(19) United States
(12) Patent Application Publication
(10) Pub. No.: US 2014/0164016 A1
(43) Pub. Date: Jun. 12, 2014

(54) METHOD AND APPARATUS FOR PROCESSING MEDICAL INFORMATION

(71) Applicant: AT&T MOBILITY II LLC., Atlanta, GA (US)

(72) Inventor: DANIEL EVANS, San Antonio, TX (US)

(73) Assignee: AT&T Mobility II LLC., Atlanta, GA (US)

(21) Appl. No.: 13/710,165

(22) Filed: Dec. 10, 2012

(51) Int. Cl. G06F 19/00

(52) U.S. Cl. CPC G06F 19/3456
USPC 705/3

(57) ABSTRACT

A method, computer readable medium and apparatus for processing medical information are disclosed. For example, the method receives the medical information associated with a customer, processes the medical information that is received to identify an event relating to a medication, updates a schedule in accordance with the event that is identified, determines if a time for executing the event on the schedule has arrived, and provides a reminder to perform the event, if the time for executing the event has arrived.

The present disclosure relates generally to communication networks and, more particularly, to a method, computer readable medium and apparatus for processing medical information via a mobile endpoint device in a wireless network, e.g., in a 3G network, a LTE (long term evolution) wireless network and the like.

### BACKGROUND

More and more customers are using smart phones to access or utilize various services. For example, a customer may use a smart phone for accessing communications services, making purchases, conducting banking transactions, accessing various multimedia services, etc.

However, medical information is still generally provided either verbally or on a printed medium such as paper. For instance, when a customer obtains a prescription medication from a pharmacist, the pharmacist will provide important information pertaining to the prescribed medication such as dosage for the medication, instructions on how to take the medication, possible side effects, and safety precautions with respect to other medications to the customer either verbally or on a paper.

### SUMMARY OF THE DISCLOSURE

In one embodiment, the present disclosure teaches a method, computer readable medium and apparatus for processing medical information. For example, the method receives the medical information associated with a customer, processes the medical information that is received to identify an event relating to a medication, updates a schedule in accordance with the event that is identified, determines if a time for executing the event on the schedule has arrived, and provides a reminder to perform the event, if the time for executing the event has arrived.

### BRIEF DESCRIPTION OF THE DRAWINGS

The teaching of the present disclosure can be readily understood by considering the following detailed description in conjunction with the accompanying drawings, in which:

FIG. 1 is a block diagram depicting an illustrative network related to the current disclosure;

FIG. 2 illustrates an exemplary network in accordance with one embodiment of the current disclosure for processing medical information via a mobile endpoint device;

FIG. 3 illustrates a flowchart of a method for processing medical information via a mobile endpoint device;

FIG. 4 illustrates a flowchart of a method for providing medical information to a customer of an enterprise; and

FIG. 5 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly teaches a method, computer readable medium and apparatus for processing medical information via a mobile endpoint device in a wireless network such as a LTE wireless network and the like. Namely, the teachings of the present disclosure can be applied via other wireless networks, e.g., Wireless Fidelity (Wi-Fi) networks or cellular networks (e.g., 2G networks, 3G networks, and the like), wherein providing medical information is beneficial to the customers. It should be noted that the term “medical information” is intended to broadly cover at least “medication information” as discussed below.

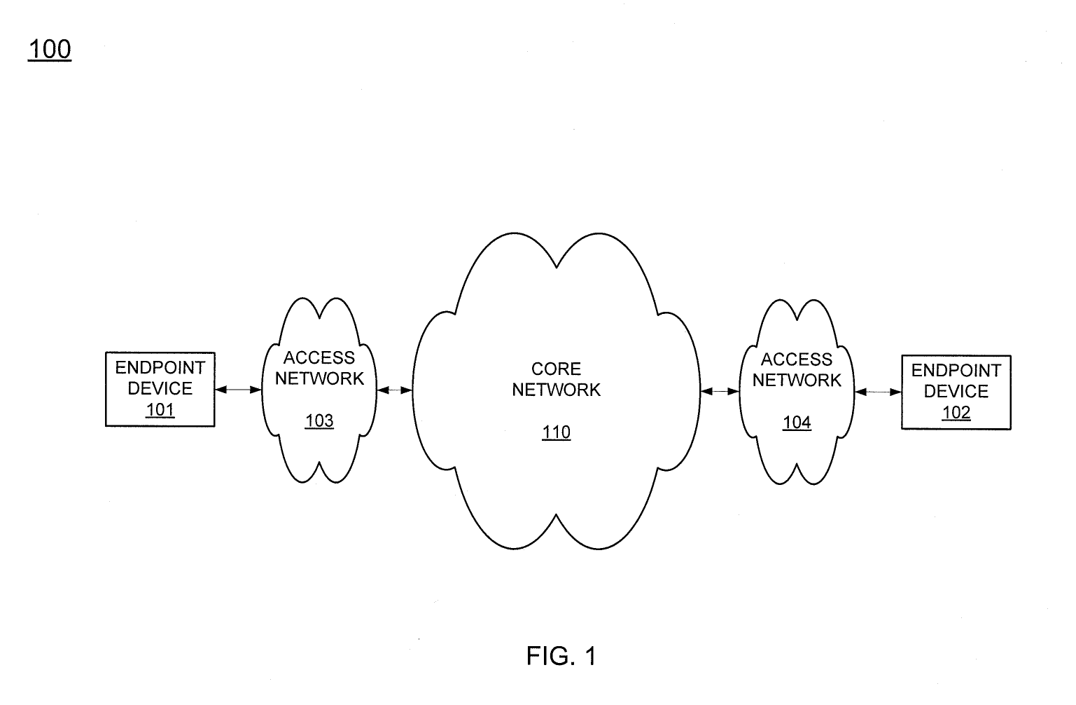

FIG. 1 illustrates an illustrative network 100 related to the present disclosure. The network 100 comprises an endpoint device 101 communicating with a core network 110 (e.g., an Internet Protocol (IP) based core backbone network supported by a service provider) via an access network 103. The network 100 also comprises an endpoint device 102 communicating with the core network 110 via an access network 104.

The endpoint devices 101-102 may comprise endpoint devices such as wireless phones, smart phones, tablets, personal computers, laptop computers, Personal Digital Assistants (PDAs), servers, routers, wire-based phones, and the like. The access networks 103 and 104 serve as a conduit to establish a connection between the endpoint devices 101-102 and one or more network elements (not shown) of the IP core network 110. The access networks 103 and 104 may each comprise a wireless local area network (WLAN), a Wireless Access Network (WAN), a cellular network, a Wi-Fi network, a Digital Subscriber Line (DSL) network, a broadband cable access network, a Local Area Network (LAN), a 3^{rd} party network, and the like.

The access networks 103 and 104 may be either directly connected to the one or more network elements (not shown) of the IP core network 110, or indirectly through another network. A wireless access network 103 or 104 may support a wireless service, e.g., Wi-Fi (Wireless Fidelity), WiMAX (Worldwide Interoperability for Microwave Access), 2G, 3G, or LTE (Long Term Evolution) or other 4G wireless services, and the like.

It should be noted that the present invention is not limited to a particular type of wireless service. It should also be noted that the network 100 as shown in FIG. 1 is only illustrative and is not limited to the network elements or types of networks as described above, i.e., there could be additional endpoint devices, access networks and network elements that are deployed but not discussed. For example, a network element that resides at the edge of a core infrastructure is typically implemented as an edge router, a media gateway, a proxy server, a border element, a firewall, a switch, and the like. A network element may also reside within the network and may be used as a Session Initiation Protocol (SIP) server, an application server with a database, a core router, or like device.

In addition, functions performed by various networks can be combined into a fewer number of networks or expanded to a greater number of networks depending on the deployment requirements. Moreover, the number of network elements, networks and/or endpoint devices is not specifically limited as shown. Any number of network elements, networks and/or endpoint devices can be deployed.

As the use of wireless technology grows, more and more customers are using smart phones to access or utilize various services. For example, a customer may use a smart phone for accessing communications services, making purchases, conducting banking transactions, accessing various multimedia services, etc. However, medical information is still provided to patients either verbally or on paper. For instance, when a customer obtains a prescription medication from a pharmacist, the pharmacist provides a dosage for the medication, instructions on how to take the medication, possible side effects, safety precautions, etc. to the customer either verbally or on a paper. The intent is for the customer to remember the details of the information that is provided and to take the medication in accordance with the information. However, the degree of compliance varies from person to person based in part on each person's ability to remember the information provided by the pharmacist.

In one embodiment, the present disclosure provides a method for providing medical information electronically to a customer. For example, the medical information is provided to the customer via the customer's mobile device.

In one embodiment, the mobile device may be a smart phone that comprises a scanner, e.g., a barcode scanner (or more broadly an image capturing device) which can read a code, e.g., a barcode, or a Quick Response (QR) code. In another embodiment, the mobile device may be a smart phone that is a Near Field Communication (NFC) device. NFC is a set of standards used to establish a radio communication between NFC devices. The NFC radio communication is generally used for devices in close proximity, e.g., physically located less than a meter apart. An NFC device refers to a device that is able to establish a radio communication with another NFC device.

In one embodiment, the medical information may be encoded using the QR code and stored in a server of an enterprise, e.g., a pharmacy, a clinic, a hospital or a doctor's office. The medical information that is encoded may be provided to the smart phone of a customer of the enterprise. For example, the barcode scanner of the mobile device may be used to scan the QR code.

In one embodiment, the QR code may be provided on a receipt obtained from a pharmacy. The customer may then perform the scanning of the QR code from the receipt via the scanner of the smart phone. In another embodiment, the QR code may be displayed on a point-of-sale (POS) device. The customer and/or enterprise personnel may then scan the QR code of the display of the POS device.

In one embodiment, a POS device of the enterprise and the smart phone may be NFC devices. The POS device may then transmit the QR code to the smart phone of the customer via the NFC standard based radio communication. For example, the smart phone may be held in close proximity to the POS device and the POS device may transmit the QR code related to a prescribed medication.

In another embodiment, the enterprise may send the QR code to the smart phone via a service provider's network. For example, the enterprise may send the QR code to a customer's smart phone, via a communication service provider's network.

In one embodiment, the smart phone decodes the QR code and processes the medication information. For example, the smart phone may process the medication information to obtain one or more of: a direction of use, a number of doses in the prescription (e.g., an inventory of the number of pills or doses (e.g., liquid doses)), side effect, refill information, prescribing doctor information, and contact information. The contact information may comprise one or more of: patient email address, patient phone number, other contact information for sending reminders to patient, guardian information, next of kin information, doctor (prescriber and/or family doctor), and/or other parties to be notified in case of non-compliance (e.g., patient not taking the mediation in a timely manner, patient not taking the mediation in the prescribed dosage, and the like).

In one embodiment, the medication information can be used by other applications within the mobile endpoint device. For example, the smart phone may then update a calendar with the direction of use of the medication. For example, the calendar may be populated with a schedule of when the medication is to be taken and when the medication is to be refilled. The schedule may also have entries for one or more reminders to be sent to the customer. The one or more reminders may be provided as audio alarms (e.g., audio tones/beeps or automated audio message, e.g., “please take your medication now” and the like), email, text message, etc. In one embodiment, the customer may select the types of reminders that he/she wishes to receive.

The smart phone then continuously tracks events on the calendar until all events are completed. For example, the smart phone may execute the schedule determining if there are any events left on the calendar. If there is at least one event left on the calendar, the method may continue to determine if a time for executing an event on the calendar has arrived. In one example, the method may determine if a time for taking a medication has arrived. In another example, the method may determine if a time for obtaining a refill of the medication has arrived. If a time for executing an event has arrived, the method may trigger an alarm to remind the customer to perform the task associated with the event. For example, the method may send a reminder to the customer to take a medication, to obtain a refill of a medication, etc.

In one embodiment, the reminder may also include direction of use and/or precautions. For example, the reminder may include the dosage, instruction not to take certain foods or drinks with the medication, warning of possible consequences, etc. For example, if a medication cannot be taken with caffeinated beverages, the reminder may include an instruction to avoid caffeinated beverages for a specified period of time.

In one embodiment, the customer performs the task associated with the event and provides an indication to the smart phone that the customer has performed the task. This feedback from the user is an important way to track that the user is following the instruction of the prescribed medication. In one embodiment, the indication is provided to the smart phone by scanning the QR code of the medication that is taken. For example, the customer may scan the QR code printed or displayed on the container of the medication each time a dose of the medication is taken from the associated container. This tracking mechanism is helpful if the user has to take a large number of different medications throughout each day.

If the smart phone receives the user feedback (e.g., inputs from key entries) or scanned indication (e.g., information received from a scanned code or information received from an NFC device), the smart phone will update the calendar, in accordance with the user feedback or scanned indication. For example, the smart phone updates the calendar to show that the event has passed and the task is accomplished. In one embodiment, the updating of the calendar comprises updating of an inventory of the medication. For example, the medication information that was obtained may include a number of doses. Then, when the customer consumes a dose of the medication, the inventory may be decremented to reflect the remaining number of doses.

If the user feedback or scanned indication is not received, the smart phone may then send a notification of a lack of compliance, e.g., continue to send reminders (e.g., audio reminders, text messages or emails) via the user's mobile endpoint device or even send a notification (e.g., text message or email) to an endpoint device (e.g., a cellular phone, a smart phone, a computer, a tablet, a laptop and the like) of a caregiver of the user. For example, the notification of the lack of compliance (e.g., email or text message) may comprise one or more of: an indication sent to a guardian, an indication sent to a next of kin, an indication sent to a prescribing doctor, an indication sent to a family doctor, an indication sent to a pharmacy, etc. In one embodiment, the customer may provide a list of recipients of the notification of the lack of compliance to the pharmacy or the list can be stored locally on the user's mobile endpoint device so that the notification can be sent directly from the user's mobile endpoint device.

In one embodiment, the medication is provided to the customer in a container that is an NFC device. For example, the container may comprise an NFC chip. In one embodiment, when the medication is dispensed (e.g., the removal (i.e., opening/closing) of the lid of the container), the NFC device of the container may transmit an indication to the NFC of the smart phone. The smart phone may then update the calendar to indicate that the customer has taken the medication.

In one embodiment, the smart phone may automatically send a refill request to a pharmacy when the number of doses remaining in the container reaches a predetermined number. For example, the number of doses may be tracked until it reaches a threshold (e.g., within a predefined number of days, weeks, etc.) for transmitting a refill request to the pharmacy. In one embodiment, the smart phone sends a reminder to the customer when the number of doses remaining reaches a predetermined threshold. For example, rather than sending a refill order to the pharmacy from which the medication was originally obtained, the smart phone reminds the customer to order the refill. In one example, the customer may be at another location and may prefer to obtain the refill from another pharmacy. In another example, the customer may wish to compare current prices from various pharmacies prior to ordering the refill. Thus, the customer may wish to select a pharmacy from which the refill is to be obtained. In one embodiment, the location of the user's mobile device may dictate whether to order the refill, e.g., through the use of Global Positioning System (GPS) information. In other words, if the location information indicates that the user is travelling, i.e., not within a local range of a home location, then the software application on the user's mobile endpoint device will not order the refill from a local pharmacy and will simply remind the user to make a refill.

In one embodiment, the alarm that is sent to the customer is terminated when the NFC of the container is placed in close proximity to the NFC of the smart phone. For example, a customer may forget to take the medication. A reminder alarm may then be triggered by the smart phone. As a result of the alarm, the customer may open the container to take the medication. The smart phone may then receive an indication from the NFC of the container confirming that the customer has taken the medication. The alarm may then be terminated.

In one embodiment, the alarm that is sent to the customer is terminated when the QR code is scanned by the smart phone. For example, a customer may forget to take the medication. A reminder alarm may then be triggered by the smart phone. As a result of the alarm, the customer may take the medication and scan the QR code displayed on the container. The smart phone may then terminate the alarm.

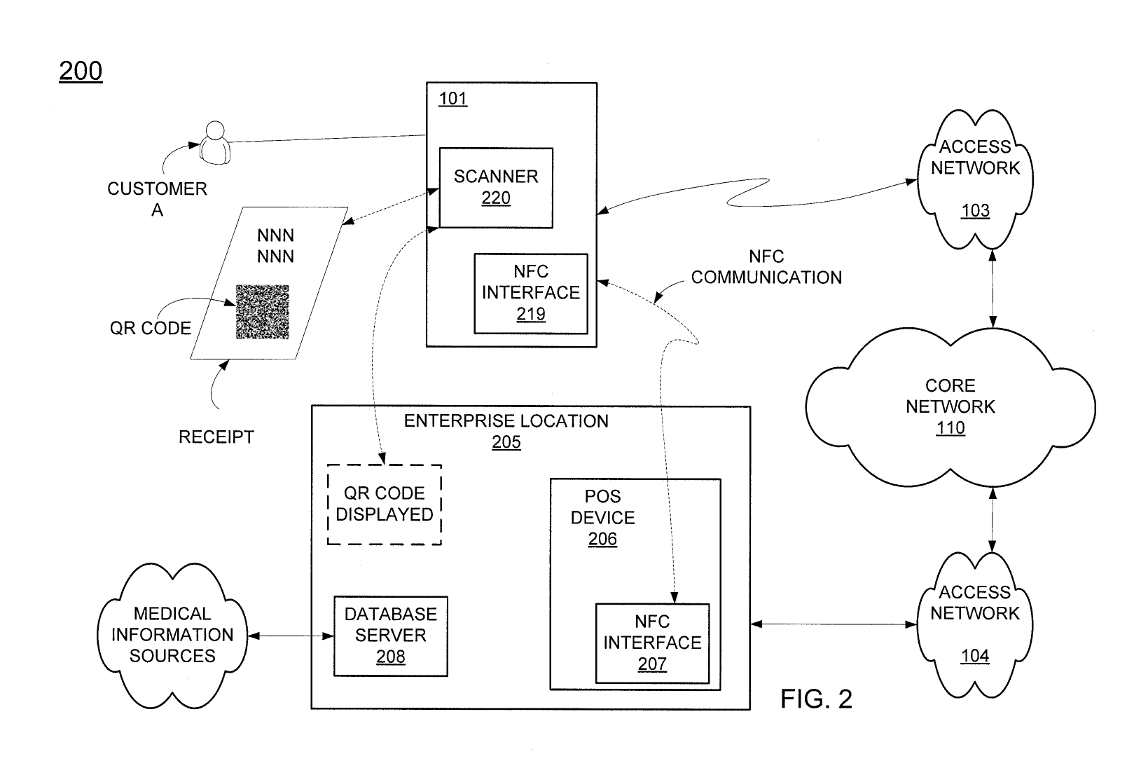

FIG. 2 illustrates an illustrative network 200 in accordance with one embodiment of the current disclosure for processing medical information via a mobile endpoint device. More specifically, the service provider may implement the method of the present disclosure for providing medication information to a customer via a user endpoint device. For example, a network service provider may provide to a customer a user mobile endpoint device (e.g., a smart phone) with a capability to receive and process medication information, populate a calendar in accordance with the medication information, track events on the calendar, send reminders and/or trigger alarms, and send notifications. The user mobile endpoint device may comprise one or more of: a scanner for reading barcodes, Quick Response (QR) codes, a decoder for decoding the barcodes or QR codes, a Near Field Communication (NFC) interface for communicating with other NFC devices, and one or more software applications for processing the medication information, populating the calendar, tracking events on the calendar, sending reminders and/or triggering alarms, and sending notifications.

An enterprise that has medical information to be given to the customer may implement a method for providing the medical information to the customer. For example, the enterprise may implement a point-of-sale device with an NFC capability for transmitting the medical information to the customer's smart phone or a display for illustrating a QR code or barcode comprising the medical information. For example, the QR code may be displayed to the customer such that the customer can use the scanner of the smart phone for receiving the QR code. The smart phone then decodes and processes the information, as described above. It should be noted that in one embodiment the received medical information may include additional information, e.g., a Uniform Resource Locator (URL) link that will allow the user's mobile endpoint device to obtain even more information.

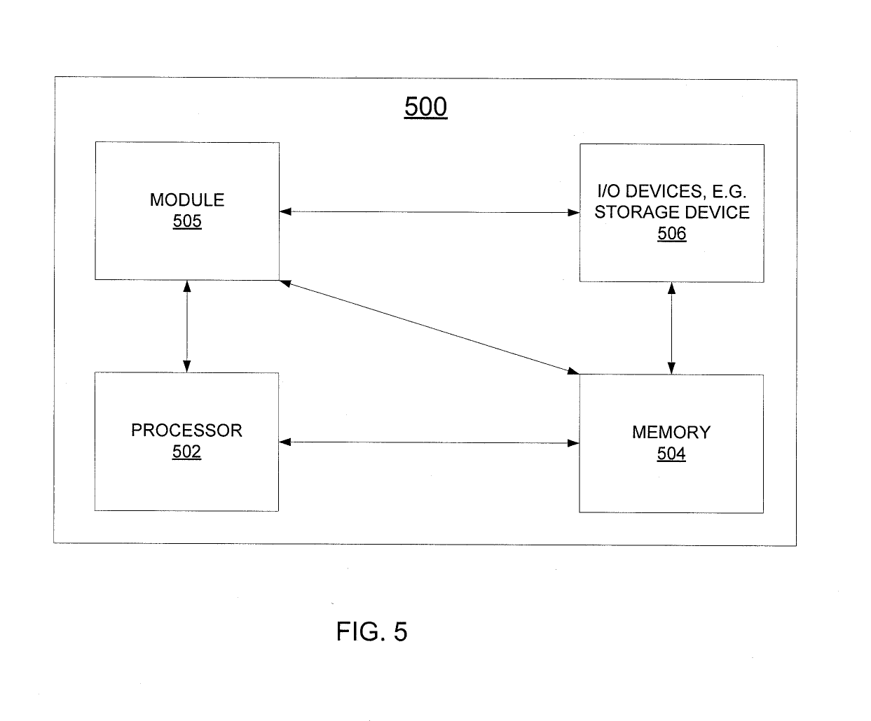

The network 200 comprises a customer endpoint device 101 of a customer A communicating with a core network 110 via an access network 103. The network 200 also comprises an enterprise location 205 that comprises a POS device 206 and a database server 208. The database server 208 may be used for storing medical information to be provided to customers. The database server 208 may be populated by accessing information on medications from various sources. For example, the various sources may be manufacturer databases, medical websites, customer instructions received from the customer's doctor, doctors' databases, etc. The POS device 206 may also communicate with the core network 110 via an access network 104. The POS device 206 comprises an NFC interface 207 that may be used to establish communication with other NFC devices. The customer endpoint device 101 comprises an NFC interface 219 and a scanner 220 for reading QR codes or barcodes. Broadly, it should be noted that QR codes and barcodes are simply “scannable codes” that can be scanned with a scanner. The user endpoint device 101 may also comprise any number of input/output devices, tangible memories and processors for implementing the method of the present disclosure, e.g., as shown in FIG. 5.

In one embodiment, the medical information may be encoded, e.g., in a QR code, and stored in the server 208. The medical information that is encoded may be provided to the customer endpoint device 101 via the POS device 206. In one embodiment, the scanner 220 may be used to scan the QR code from a receipt obtained from the enterprise. In one embodiment, the scanner 220 may be used to scan the QR code being displayed via the POS device 206. In one embodiment, the POS device 206 may transmit the QR code to the user endpoint device 101 via the NFC interface 207 of the POS device 206 and the NFC interface 219 of the user endpoint device 101. In one embodiment, the POS device 206 may transmit the QR code or the medical information itself without the QR code to the user endpoint device 101 via a service provider network. For example, the QR code may be transmitted via the access network 104, the core network 110 and the access network 103.

In one embodiment, the user mobile endpoint device 101 decodes the QR code and processes the medical information. For example, the user endpoint device 101 may process the medical information to obtain medication information such as one or more of: a direction of use, a number of doses (e.g. inventory), side effect, refill information, prescribing doctor information, and contact information. The user mobile endpoint device 101 then updates a calendar with the direction of use. The schedule may comprise one or more entries for: when a medication is to be taken, when and if the medication is to be refilled, and reminders to be sent to the customer.

In one embodiment, the reminder may comprise a direction of use and/or precautions. For example, the reminder may include the dosage for the medication, instruction not to take certain foods or drinks with the medication, warning of possible consequences, etc.

The user mobile endpoint device 101 then waits to receive user feedback or scanned indication from the customer that the task associated with the event has been executed. For example, the customer may take the medication and scan the QR code as a scanned indication that the medication has been taken. In another example, the medication may be in a container that is an NFC device. Then, the customer may take the medication and place the user mobile endpoint device 101 near the container. The container may then transmit the indication to the user mobile endpoint device 101 via the NFC interfaces of the container and the user mobile endpoint device 101.

If the user mobile endpoint device 101 receives an indication from the customer that the task is performed, the user mobile endpoint device 101 updates the calendar in accordance with the user feedback or scanned indication. For example, the user mobile endpoint device 101 updates the calendar to show that the event has passed and the medication is taken or the refill is obtained.

If the user mobile endpoint device 101 does not receive the user feedback or scanned indication, the user mobile endpoint device 101 sends a notification indicating a lack of compliance. In one embodiment, the notification of the lack of compliance may be sent to the customer (e.g., email or text message). In one embodiment, the notification of the lack of compliance may be sent to one or more of caregivers such as: a guardian, a next of kin, a prescribing doctor, a family doctor, etc.

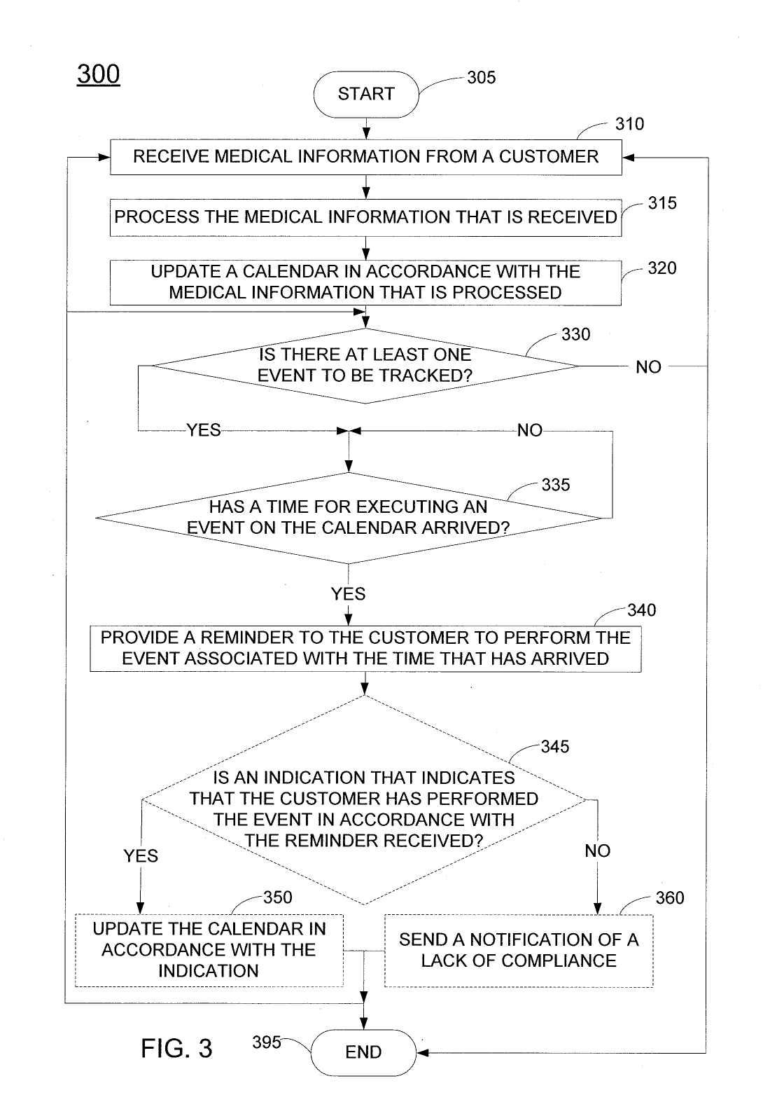

FIG. 3 illustrates a flowchart of a method 300 for processing medical information via a mobile endpoint device. In one embodiment, method 300 may be implemented in a user endpoint device, e.g., a mobile endpoint device. For example, a service provider may provide the medical information to the user endpoint device of a customer, wherein the ability to receive the medical information is implemented in the user endpoint device. Method 300 starts in step 305 and proceeds to step 310.

In step 310, method 300 receives medical information for a customer. For example, a smart phone receives medical information that is encoded using a QR code from an enterprise, e.g., a pharmacy. For example, the enterprise may acquire the medical information from various medical sources such that the medical information can be provided to a customer. For instance, the various medical sources may comprise: physicians, pharmaceutical companies, government entities that approve medications and/or provide guidelines for use of medications, etc.

In one embodiment, the medical information is received via a scanner of the smart phone. For example, the medical information is received by scanning a QR code from a receipt received after the purchase of a prescribed medication. In another embodiment, the medical information is received by scanning a QR code displayed on a point-of-sale device. In another embodiment, the medical information is received via an NFC standard based communication between the smart phone and a point-of-sale device. In another embodiment, the medical information is received via a communication service provider's network.

In step 315, method 300 processes the medical information that is received. For example, the smart phone decodes the QR code and processes the medical information. In one embodiment, the processing of the medical information is performed to obtain the medication information comprising one or more of: a direction of use, a number of doses, a side effect, refill information, prescribing doctor information, and contact information. In one embodiment, the contact information comprises one or more of: a patient email address, a patient phone number or mobile phone number, a patient residence or home address, other contact information for sending reminders to the patient, caregiver information, guardian information, next of kin information, medical professionals, e.g., a doctor, a pharmacist, or a nurse (prescriber and/or family doctor), other parties to be notified in case of non-compliance, etc.

In step 320, method 300 updates a calendar in accordance with the medical information that is processed. It should be noted that the term “calendar” is broadly intended to be covered by the term “schedule”. In other words, method 300 may update a schedule associated with the customer without the need to refer to a specific calendar, e.g., tracking medication usage for the next 7 days without the need to refer to specific dates on a calendar. For example, the calendar or schedule may be populated with a time line as to: when a medication is to be taken, when the medication is to be refilled, a direction of use, etc. In one embodiment, the calendar further comprises a time line of one or more reminders to be sent to the customer. In one embodiment, each reminder comprises an audio alarm. In one embodiment, a reminder may comprise an email message or a text message. In one embodiment, the one or more reminders and their types (audible tones or messaging) are selectable by the customer.

In step 330, method 300 determines if there is at least one event to be tracked. If there is at least one event to be tracked, the method proceeds to step 335. Otherwise, the method either proceeds to step 395 to end the process or to step 310 to receive more medical information.

In step 335, method 300 determines if a time for executing an event on the calendar has arrived. In one example, the method may determine if a time for taking a medication has arrived. In another example, the method may determine if a time for obtaining a refill of the medication has arrived. If a time for executing an event has arrived, the method proceeds to step 340. Otherwise, the method returns to step 335, to continue determining if a time for executing an event has arrived.

In step 340, method 300 provides a reminder to the customer to perform the event associated with the time that has arrived. For example, the method may send a reminder to the customer to take a medication, to obtain a refill of a medication, etc.

In one embodiment, the reminder comprises a direction for performing the event. For example, the reminder may include a dosage for the medication. For example, the reminder may comprise an audio message, “please take two pills of aspirins now” and the like.

In optional step 345, method 300 determines if a user feedback or scanned indication is received, wherein the user feedback or scanned indication indicates that the customer has performed the event in accordance with the reminder. For example, the customer may perform the task associated with the event and provide a user feedback or scanned indication to the smart phone that the customer has performed the task. If the user feedback or scanned indication is received, then the method proceeds to step 350. Otherwise, method 300 proceeds to step 360.

In one embodiment, the scanned indication is provided by scanning the QR code. For example, the customer may scan the QR code printed or displayed on the container of the medication.

In optional step 350, method 300 updates the calendar in accordance with the user feedback or scanned indication. For example, the smart phone updates the calendar to show that the event has passed and the task is accomplished. The method either proceeds to step 310 to receive more medical information, to step 330 to determine if there is at least one event to be tracked, or to step 395 to end the process.

In optional step 360, method 300 sends a notification of a lack of compliance. In one embodiment, the notification of the lack of compliance may comprise one or more of: a notification sent to the customer (e.g., email or text message), and a notification sent to a caregiver such as a guardian, a next of kin, a prescribing doctor, a family doctor, a nurse, a pharmacist, etc. The method then either proceeds to step 310 to receive more medical information, to step 330 to determine if there is at least one event to be tracked, or to step 395 to end the process.

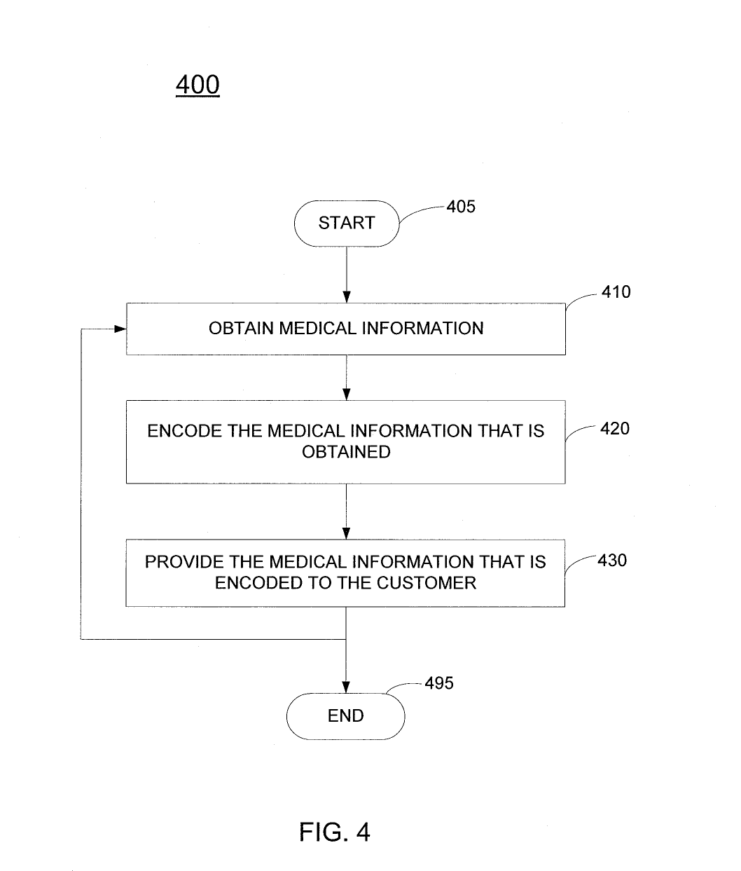

FIG. 4 illustrates a flowchart of a method 400 for providing medical information to a customer of the enterprise. In one embodiment, the medical information is first obtained by the enterprise from various sources. For example, the various sources may be manufacturer databases, medical websites, customer instructions, government entities, medical professionals' offices, etc. The medical information is then processed into an electronic form for transmission, e.g., encoded into a QR code or encoded into a NFC format. The encoded medical information is then provided to the customer via a POS device of the enterprise and a smart phone of the customer. Method 400 starts in step 405 and proceeds to step 410.

In step 410, method 400 obtains medical information. For example, the medical information may be obtained from various medical sources such as manufacturer databases, medical websites, subscriber instructions, etc.

In step 420, method 400 encodes the medical information that is obtained into an electronic form. For example, the medical information may be encoded, e.g., into a QR code, and stored in a server. In one embodiment, the received medical information may already be in the desired electronic form, e.g., the manufacturer of the prescribed medication may have already created the electronic form of the medical information that can be downloaded by pharmacies to be distributed with the prescribed medication.

In step 430, method 400 provides the medical information that is encoded to the user mobile endpoint device of the customer. In one embodiment, a scanner of a smart phone of the customer may be used to scan the QR code from a receipt obtained from the enterprise. In one embodiment, the scanner of the smart phone of the customer may be used to scan the QR code from a display of a POS device. In one embodiment, the medical information that is encoded may be provided to the customer via an NFC interface of a POS device and an NFC interface of a smart phone. In one embodiment, the medical information that is encoded may be transmitted to the smart phone via a service provider network. The method then proceeds to step 410 to obtain more medical information or to step 495 to end the process.

It should be noted that although not specifically specified, one or more steps or operations of each of the respective methods 300-400 may include a storing, displaying and/or outputting step as required for a particular application. In other words, any data, records, fields, and/or intermediate results discussed in each of the respective methods can be stored, displayed and/or outputted to another device as required for a particular application. Furthermore, steps, blocks, or operations in each of FIGS. 3-4 that recite a determining operation or involve a decision do not necessarily require that both branches of the determining operation be practiced. In other words, one of the branches of the determining operation can be deemed as an optional step.

FIG. 5 depicts a high-level block diagram of a general-purpose computer suitable for use in performing the functions described herein. As depicted in FIG. 5, the system 500 comprises a hardware processor element 502 (e.g., a CPU), a memory 504, e.g., random access memory (RAM) and/or read only memory (ROM), a module 505 for processing medical information in a wireless network, and various input/output devices 506 (e.g., storage devices, including but not limited to, a tape drive, a floppy drive, a hard disk drive or a compact disk drive, a receiver, a transmitter, a scanner (e.g., a barcode scanner), an NFC interface, a speaker, a display, a speech synthesizer, an output port, and a user input device (such as a keyboard, a keypad, a mouse, and the like)).

It should be noted that the teachings of the present disclosure can be implemented in software and hardware, e.g., using application specific integrated circuits (ASIC), a general purpose computer or any other hardware equivalents, e.g., computer readable instructions pertaining to the method(s) discussed above can be used to configure a hardware processor to perform operations of the above disclosed methods. For example, a computer-readable medium may be in communication with the processor, where the computer-readable medium having stored thereon a plurality of instructions which, when executed by the hardware processor, cause the hardware processor to perform the operations (e.g., methods 300-400) as disclosed above. It should be noted that the processor can be configured or programmed to cause other devices to perform one or more operations as discussed above. In other words, the processor may serve the function of a central controller directing other devices to perform the one or more operations as discussed above.

In one embodiment, the present module or process 505 for processing medical information in a wireless network can be implemented as computer-executable instructions (e.g., a software program comprising computer-executable instructions) and loaded into memory 504 and executed by the hardware processor 502 to implement the steps, functions or operations as discussed above. As such, the present method 505 for processing medical information in a wireless network (including associated data structures) of the present disclosure can be stored on a non-transitory (e.g., tangible or physical) computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for processing medical information, comprising:
receiving, via a processor, the medical information associated with a customer;
processing, via the processor, the medical information that is received to identify an event relating to a medication;
updating, via the processor, a schedule in accordance with the event that is identified;
determining, via the processor, if a time for executing the event on the schedule has arrived; and
providing, via the processor, a reminder to perform the event, if the time for executing the event has arrived.

2. The method of claim 1, wherein the medical information is received via a scanner.

3. The method of claim 2, wherein the medical information is received by the scanner scanning a code from a receipt.

4. The method of claim 2, wherein the medical information is received by the scanner scanning a code displayed on a point-of-sale device.

5. The method of claim 1, wherein the medical information is received via a near field communication interface.

6. The method of claim 1, wherein the medical information is received via a communication service provider's network.

7. The method of claim 1, wherein the medical information comprises a direction of use for the medication.

8. The method of claim 1, wherein the medical information comprises refill information.

9. The method of claim 1, wherein the medical information comprises contact information.

10. The method of claim 9, wherein the contact information comprises one or more of: an email address of the customer, a phone number of the customer, caregiver contact information of the customer, and physician contact information of the customer.

11. The method of claim 1, wherein the updating the schedule comprises updating the schedule with respect to an inventory of the medication.

12. The method of claim 1, wherein the event comprises an event for taking the medication.

13. The method of claim 1, wherein the event comprises an event for obtaining a refill of the medication.

14. The method of claim 13, wherein a request for obtaining a refill of the medication is sent when a number of remaining doses of the medication reaches a threshold.

15. The method of claim 1, further comprising:
determining if a user feedback is received, wherein the user feedback indicates that the customer has performed the event in accordance with the reminder;
updating the schedule in accordance with the user feedback, if the user feedback indicates that the customer has performed the event; and
sending a notification of a lack of compliance, if the user feedback is not received.

16. The method of claim 15, wherein the notification of the lack of compliance comprises a notification sent to the customer.

17. The method of claim 15, wherein the notification of the lack of compliance comprises a notification sent to an endpoint device of a caregiver of the customer.

18. The method of claim 1, further comprising:
determining if a scanned indication is received, wherein the scanned indication indicates that the customer has performed the event in accordance with the reminder;
updating the schedule in accordance with the scanned indication, if the scanned indication indicates that the customer has performed the event; and
sending a notification of a lack of compliance, if the scanned indication is not received.

19. A tangible computer-readable medium storing a plurality of instructions which, when executed by a processor, cause the processor to perform operations for processing medical information, the operations comprising:
receiving the medical information associated with a customer;
processing the medical information that is received to identify an event relating to a medication;
updating a schedule in accordance with the event that is identified;
determining if a time for executing the event on the schedule has arrived; and
providing a reminder to perform the event, if the time for executing the event has arrived.

20. An apparatus for processing medical information, comprising:
a processor; and
a computer-readable medium storing a plurality of instructions which, when executed by the processor, cause the processor to perform operations, the operations comprising:
receiving the medical information associated with a customer;
processing the medical information that is received to identify an event relating to a medication;
updating a schedule in accordance with the event that is identified;
determining if a time for executing the event on the schedule has arrived; and
providing a reminder to perform the event, if the time for executing the event has arrived.
